(19) United States
(12) Patent Application Publication
(10) Pub. No.: US 2025/0052556 A1
(43) Pub. Date: Feb. 13, 2025

(54) Optic Height Measuring Tool

(71) Applicant: Joseph Andrew Lukowicz, Racine, WI (US)

(72) Inventor: Joseph Andrew Lukowicz, Racine, WI (US)

(21) Appl. No.: 18/801,082

(22) Filed: Aug. 12, 2024

Related U.S. Application Data
(60) Provisional application No. 63/518,811, filed on Aug. 10, 2023.

(51) Int. Cl. G01B 5/06; G01B 3/04

(52) U.S. Cl. CPC G01B 5/061; G01B 3/04

(57) ABSTRACT

The optical height measuring tool measures the distance between the firearm scope and the firearm barrel. The chamber end is placed within the barrel of a firearm at the firearm barrel chamber. The lateral arm is then attached to the bolt adapter. The sliding ruler is attached to the lateral arm and slides the ruler adapter onto the arm portion of the lateral arm. The sliding ruler can move along the arm portion. The adjustable height measurement apparatus is then attached to the sliding ruler by connecting the measurement indicator to the measuring portion of the sliding ruler. The adjustable height measurement apparatus may be moved vertically along the measuring portion of the sliding ruler while the ruler adapter of the sliding ruler is moved horizontally along the arm portion of the lateral arm in order to securely position the scope interface around the firearm scope.

### FIELD OF THE INVENTION

The present invention relates generally to firearm accessories, and specifically to a tool for measuring the height of a firearm sight relative to the barrel.

### BACKGROUND OF THE INVENTION

Long range shooting is done both in hunting settings and in competition settings. In the case of competition shooting or associated training/practice, ballistic calculators are commonly used to aid in the calculation of the bullet flight path under specific conditions. These calculators may collect a wide range of data about atmospheric conditions, such as wind speed, altitude, and humidity. Additionally, the calculators may collect firearm/bullet information such as bullet weight, initial velocity, and shooting angle. While most of this information is readily available to the shooter based on the gun specifications, measurement tools, and available weather information, one piece of information that does not have a simple measurement tool is the sight/scope height.

To measure the height of a scope or sight, users may in some cases refer to the specifications of their firearm, though adjustments/replacements are so commonly made to sights that alternative measurements are generally needed. Approximate measurements can be made by aligning a ruler or other measuring device along the side of the firearm, but due to the importance of exact measurements in ballistic calculations, this approximation method is not ideal.

### BRIEF DESCRIPTION OF THE DRAWINGS

FIG. 1 is a top front perspective view of the present invention.

FIG. 2 is a bottom rear perspective view of the present invention.

FIG. 3 is a front elevation view of the present invention.

FIG. 4 is a rear elevation view of the present invention.

FIG. 5 is a top plan view of the present invention.

FIG. 6 is a bottom plan view of the present invention.

FIG. 7 is a left-side elevation view of the present invention.

FIG. 8 is a right-side elevation view of the present invention.

FIG. 9 is a top front perspective view of the adjustable height measurement apparatus of the present invention.

FIG. 10 is a top front perspective view of the bolt adapter of the present invention.

FIG. 11 is a top front perspective view of the lateral arm of the present invention.

FIG. 12 is a top front perspective view of the sliding ruler of the present.

FIG. 13 is an illustration of the present invention connected to a firearm.

### DETAILED DESCRIPTION OF THE INVENTION

All illustrations of the drawings are for the purpose of describing selected versions of the present invention and are not intended to limit the scope of the present invention.

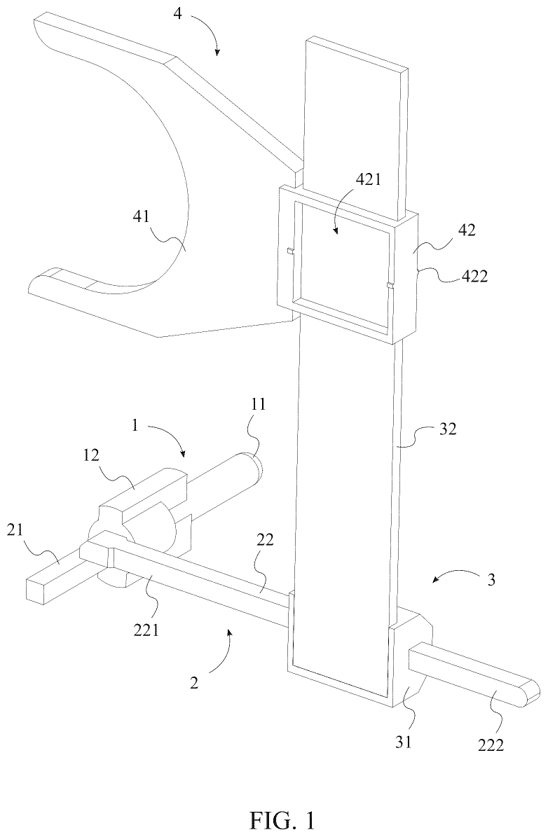

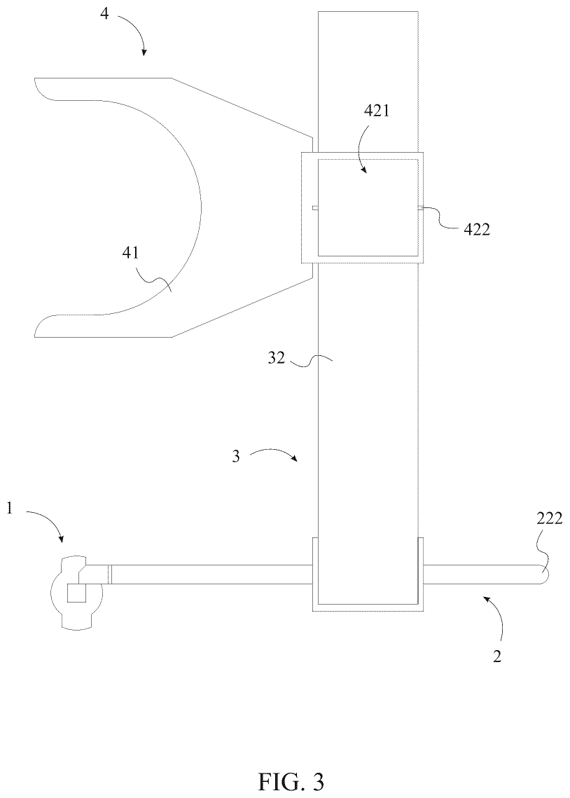

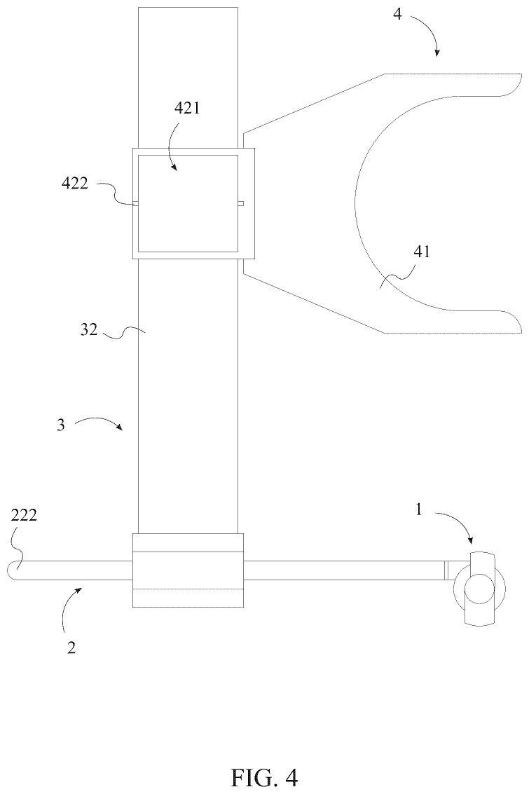

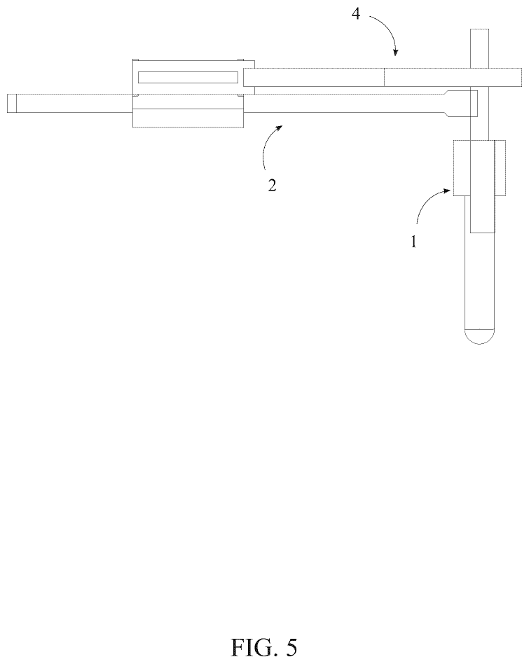

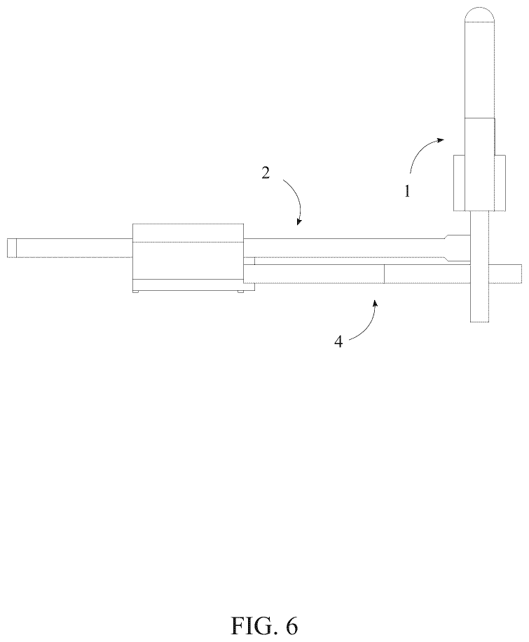

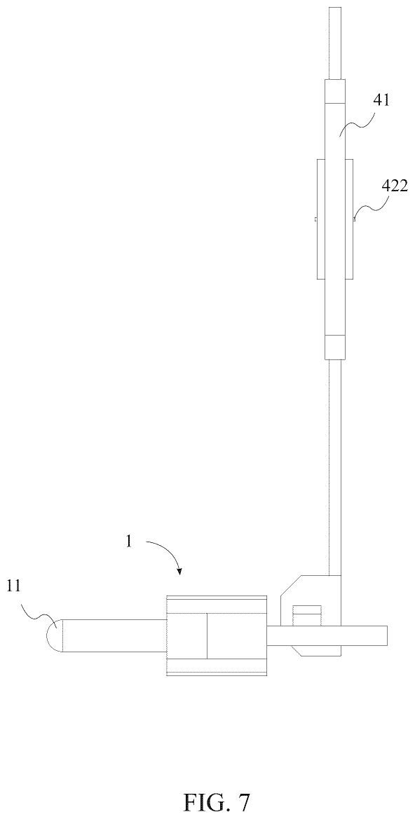

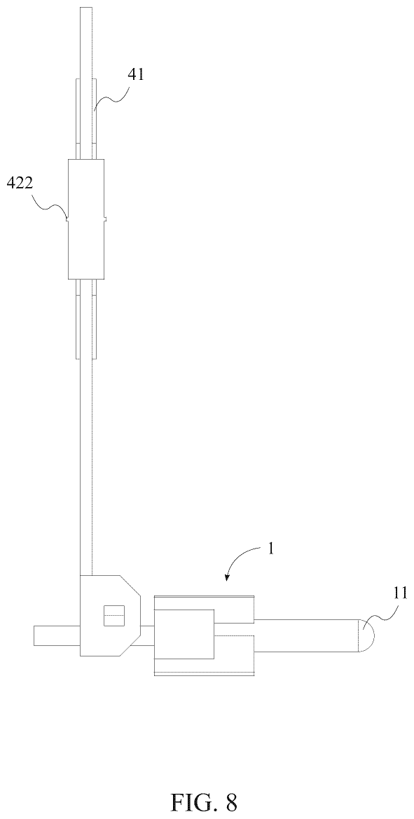

The present invention is an optical sight measurement tool that interfaces with the components of the firearm to easily and adjustably measure the optical sight height relative to the barrel for a variety of rifles and similar firearms. Referring to FIG. 1-13, the present invention is an optical sight measurement tool for firearms configured to accurately measure the vertical distance between a sight or scope of a firearm and the barrel chamber of the firearm. The optical sight height measurement apparatus comprises a bolt adapter 1, a lateral arm 2, a sliding ruler 3, and an adjustable height measurement apparatus 4. These components are arranged and connected in a manner that interfaces simultaneously with the scope and the barrel chamber of a firearm, herein referred to as a firearm scope 6 and a firearm barrel 5, to provide accurate height measurement.

In reference to FIG. 1, the optical height measuring tool comprises a bolt adapter 1, a lateral arm 2, a sliding ruler 3, and an adjustable height measurement apparatus 4. The bolt adapter 1 further comprises a chamber end 11 and an attachment end 12. The lateral arm 2 further comprises a bolt attachment 21 and an arm portion 22. The sliding ruler 3 comprises a ruler adapter 31 and a measuring portion 32. The adjustable height measurement apparatus 4 comprises a scope interface 41 and a measurement indicator 42. The bolt adapter 1 engages with a firearm barrel 5. Accordingly, the bolt adapter 1 creates a starting point for height measurement at the center of the firearm barrel 5. The bolt adapter 1 may be specifically shaped to accommodate the shapes of various firearm barrel 5s and chambers. The lateral arm 2 connects the bolt adapter 1 to the bottom of the sliding ruler 3. Consequently, the lateral arm 2 enables the sliding ruler 3 to be positioned in an unobstructed position away from the firearm. The sliding ruler 3 mechanically couples to the lateral arm 2. The sliding ruler 3 is an adjustable measurement tool configured to give a reference of distance away from the arm portion 22 of the lateral arm 2. As a result, the sliding ruler 3 may move along the lateral arm 2 as needed for measuring. The sliding ruler 3 slides along the lateral arm 2. Thus, the sliding ruler 3 only moves horizontally along the lateral arm 2. The adjustable height measurement apparatus 4 mechanically couples to the sliding ruler 3. So, the adjustable height measurement apparatus 4 moves vertically along the sliding ruler 3. The adjustable height measurement apparatus 4 engages with a firearm scope 6. Accordingly, the adjustable height measurement apparatus 4 is configured to attach the measuring portion 32 of the sliding ruler 3 to the firearm scope 6 in order to identify the height of the firearm scope 6 relative to the firearm barrel 5.

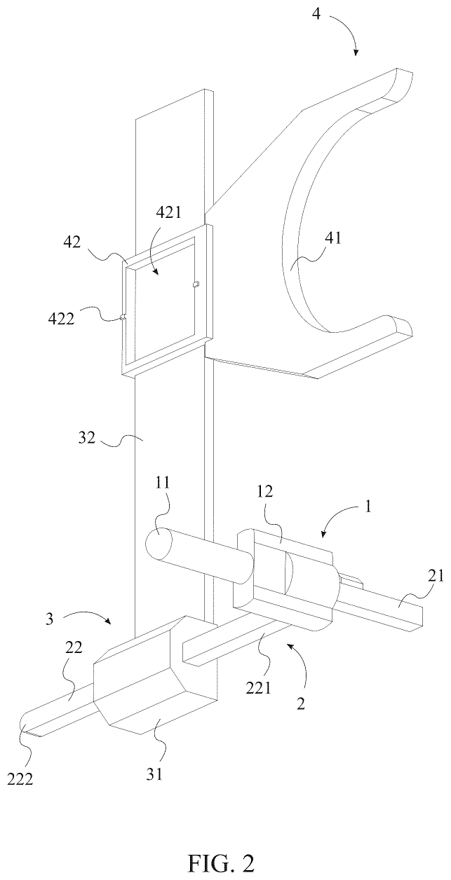

In reference to FIG. 2, the chamber end 11 is positioned along the bolt adapter 1 opposite the attachment end 12. The chamber end 11 engages within a firearm barrel 5. Consequently, the chamber end 11 is a cylindrical shaped member that fits within a firearm barrel 5 chamber. The attachment end 12 further comprises an attachment bore 121. The attachment bore 121 is a cavity that passes into the attachment end 12 and is of a square or rectangular shape. In an alternative embodiment the attachment bore 121 utilizes a different shaped bore.

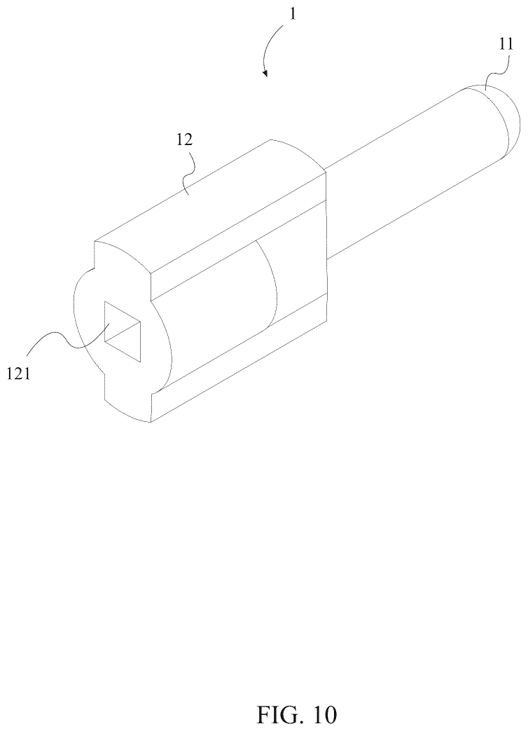

Further, the attachment bore 121 is a cavity as seen in FIG. 10. The attachment bore 121 integrates within the attachment end 12. As a result, the attachment bore 121 attaches to the attachment end 12. In an alternative embodiment the lateral arm 2 and the bolt adapter 1 are formed in a single piece, removing the need to connect the two components through the attachment bore 121. Furthermore, the bolt adapter 1 further comprises a perimetric feature in an alternative embodiment. The perimetric feature is an additional material that extends beyond the chamber end 11. The perimetric feature is a combination of cavities. Thus, the perimetric feature aids in securing the bolt adapter 1 to the firearm barrel 5. The perimetric feature matches the shape of the firearm barrel 5 chamber. In an alternative embodiment the perimetric feature may be any combination of cavities, protrusions, or features that enable for secure combination with desired firearm barrel 5 chambers.

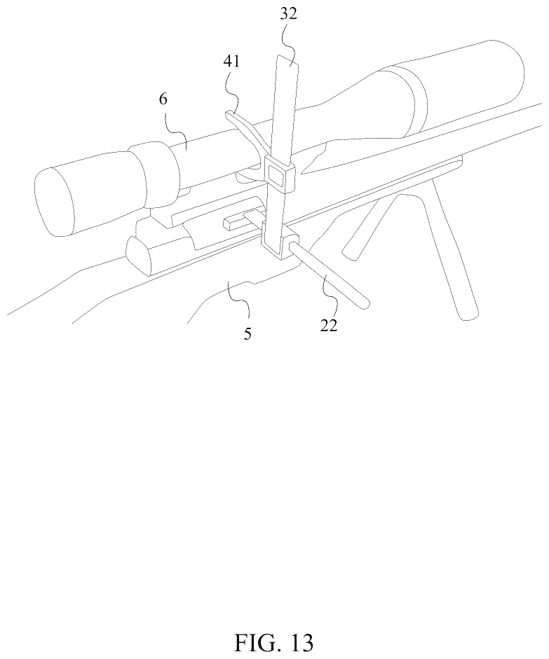

In reference to FIG. 13, the lateral arm 2 positions the sliding ruler 3 in an unobstructed position away from the firearm barrel 5. So, the sliding ruler 3 does not interfere with the firearm barrel 5 operating correctly. The bolt attachment 21 engages with the bolt adapter 1 at the attachment bore 121. The bolt attachment 21 is a rectangular prism of similar size and dimensions as the attachment bore 121. In an alternative embodiment the bolt attachment 21 utilizes a different shape that is similar to the attachment bore 121.

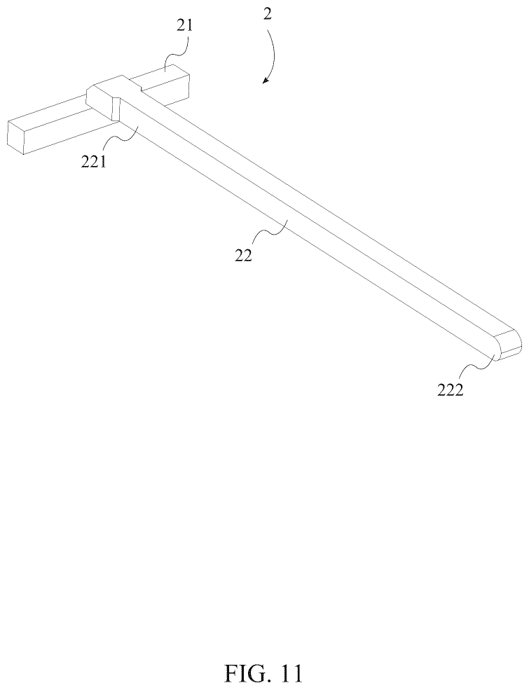

Further, the arm portion 22 protrudes from the bolt attachment 21. The arm portion 22 is an elongated member that is positioned perpendicularly to the firearm barrel 5 when connected to the bolt adapter 1. The arm portion 22 further comprises a proximal end 221 and a distal end 222. The distal end 222 is rounded to enable more seamless engagement with the sliding ruler 3. Furthermore, the proximal end 221 is positioned along the arm portion 22 opposite the distal end 222, as seen in FIG. 11. Accordingly, the proximal end 221 is attached to the bolt attachment 21 and the distal end 222 extends away from the bolt attachment 21. The proximal end 221 secures to the bolt attachment 21. The sliding ruler 3 engages along the arm portion 22 in between the proximal end 221 and the distal end 222. Consequently, the sliding ruler 3 can be moved toward or away from the firearm by moving along the arm portion 22.

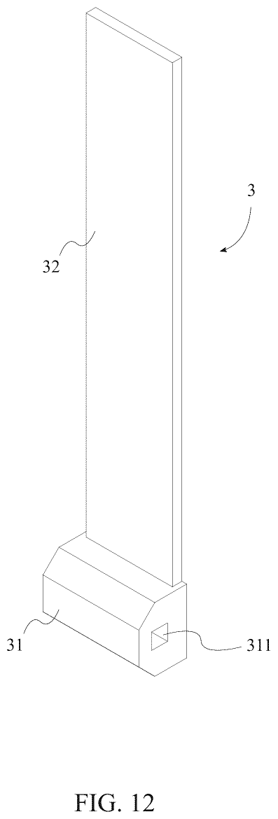

In reference to FIG. 12, the ruler adapter 31 further comprises an arm aperture 311. The arm aperture 311 engages with the arm portion 22 of the lateral arm 2. This allows the ruler adapter 31 to slide along the arm portion 22 toward and away from the bolt adapter 1. The ruler adapter 31 traverses along the arm portion 22, towards and away from the lateral arm 2. The measuring portion 32 further comprises a plurality of visual indicators, a first end and a second end. The plurality of visual indicators integrates along the measuring portion 32. The plurality of visual indicators is a series of markings. As a result, the plurality of visual indicators lists the distance away from the first end of the measuring portion 32. The measuring portion 32 is effectively a ruler configured to show the vertical distance away from the lateral arm 2. The measuring portion 32 positions perpendicularly to the arm portion 22.

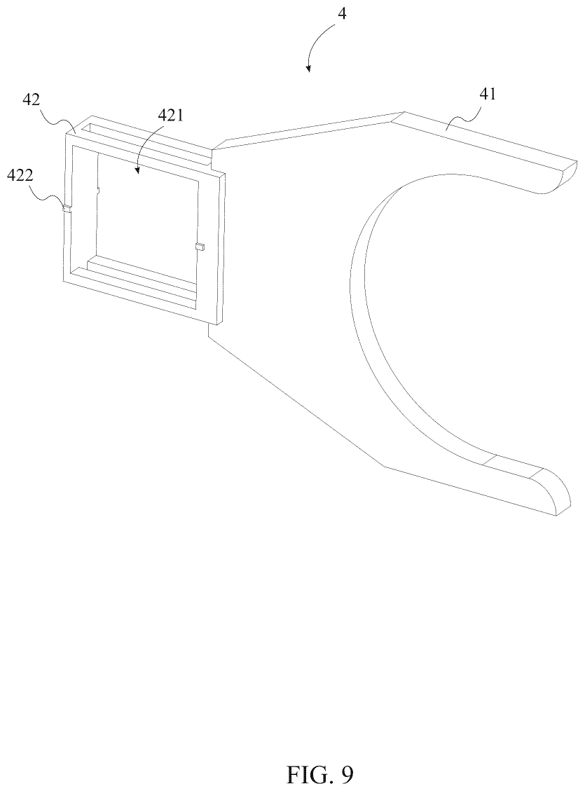

In reference to FIG. 9, the scope interface 41 engages with a firearm scope 6. The scope interface 41 is preferably a partially circular body having two prongs configured to extends around the scope of a firearm. The scope interface 41 accommodates various firearm scope 6 sizes. The partially circular body of the scope interface 41 may include tapering curved forms, allowing the scope interface 41 to effectively engage with multiple scope sizes. The scope interface 41 is preferably circular to match the common shape of a scope but may form different shapes depending on the firearm. The measurement indicator 42 further comprises a slot 421 and a measurement notch 422.

Further, the measurement indicator 42 engages with the measuring portion 32 of the sliding ruler 3, as seen in FIG. 2. As a result, the measurement indicator 42 slides between the first end and the second end of the measuring portion 32. The measurement indicator 42 slides along the measuring portion 32 of the sliding ruler 3 in between the first end and second end. The measurement notch 422 indicates the position of the measurement indicator 42 relative to the plurality of visual indicators along the measuring portion 32. The measurement indicator 42 is connected to the scope interface 41 with the measurement notch 422 positioned halfway between the two prongs of the scope interface 41, effectively positioning the measurement notch 422 at the center point of the scope when the scope interface 41 is engaged with the scope. The adjustable height measurement apparatus 4 preferably extends perpendicular to the sliding ruler 3.

In use, as shown in FIG. 1, the chamber end 11 of the bolt adapter 1 is placed within the barrel of a firearm at the firearm barrel 5 chamber or equivalent position. The lateral arm 2 is then attached to the attachment bore 121 of the bolt adapter 1. The sliding ruler 3 is attached to the lateral arm 2 by sliding the ruler adapter 31 onto the arm portion 22 of the lateral arm 2. The sliding ruler 3 can be moved toward or away from the firearm by moving along the arm portion 22 between the distal end 222 and the proximal end 221. The adjustable height measurement apparatus 4 is then attached to the sliding ruler 3 by connecting the measurement indicator 42 to the measuring portion 32 of the sliding ruler 3. The adjustable height measurement apparatus 4 may be moved vertically along the measuring portion 32 of the sliding ruler 3 while the ruler adapter 31 of the sliding ruler 3 is moved horizontally along the arm portion 22 of the lateral arm 2 in order to securely position the two prongs of the scope interface 41 around the scope of the firearm. With all the components in place, the user may then reference the plurality of visual indicators on the measuring portion 32 of the sliding ruler 3 and note the height of the scope based on the positioning of the measurement indicator 42 relative to the measuring portion 32 of the sliding ruler 3. The present invention may be attached to a firearm in either a left or right orientation depending on the orientation of the firearm.

Although the invention has been explained in relation to its preferred embodiment, it is to be understood that many other possible modifications and variations can be made without departing from the spirit and scope of the invention as hereinafter claimed.

What is claimed is:

1. An optical height measuring tool comprising:
a bolt adapter;
a lateral arm;
a sliding ruler;
an adjustable height measurement apparatus;
the bolt adapter comprising a chamber end and an attachment end;
the lateral arm comprising a bolt attachment and an arm portion;
the sliding ruler comprising a ruler adapter and a measuring portion;
the adjustable height measurement apparatus comprising a scope interface and a measurement indicator;
the bolt adapter engaging with a firearm barrel;
the lateral arm connects the bolt adapter to the bottom of the sliding ruler;
the sliding ruler mechanically coupling to the lateral arm;
the sliding ruler sliding along the lateral arm;
the adjustable height measurement apparatus mechanically coupling to the sliding ruler; and
the adjustable height measurement apparatus engaging with a firearm scope.

2. The optical height measuring tool as claimed in claim 1 comprising:
the chamber end being positioned along the bolt adapter opposite the attachment end;
the chamber end engaging within a firearm barrel; and
the attachment end further comprising an attachment bore.

3. The optical height measuring tool as claimed in claim 2 comprising:
the attachment bore being a cavity; and
the attachment bore integrating within the attachment end.

4. The optical height measuring tool as claimed in claim 2 comprising:
the bolt adapter further comprising a perimetric feature in an alternative embodiment;
the perimetric feature being a combination of cavities; and
the perimetric feature matching the shape of the firearm barrel chamber.

5. The optical height measuring tool as claimed in claim 1 comprising:
the lateral arm positioning the sliding ruler in an unobstructed position away from the firearm barrel; and
the bolt attachment engaging with the bolt adapter at the attachment bore.

6. The optical height measuring tool as claimed in claim 5 comprising:
the arm portion protruding from the bolt attachment; and
the arm portion further comprising a proximal end and a distal end.

7. The optical height measuring tool as claimed in claim 6 comprising:
the proximal end being positioned along the arm portion opposite the distal end;
the proximal end securing to the bolt attachment; and
the sliding ruler engaging along the arm portion in between the proximal end and the distal end.

8. The optical height measuring tool as claimed in claim 1 comprising:
the ruler adapter further comprises an arm aperture;
the arm aperture engaging with the arm portion of the lateral arm;
the ruler adapter traversing along the arm portion, towards and away from the lateral arm;
the measuring portion further comprising a plurality of visual indicators, a first end and a second end;
the plurality of visual indicators integrating along the measuring portion;
the plurality of visual indicators being a series of markings; and
the measuring portion positioning perpendicularly to the arm portion.

9. The optical height measuring tool as claimed in claim 1 comprising:
the scope interface engaging with a firearm scope;
the scope interface accommodating various firearm scope sizes; and
the measurement indicator further comprising a slot and a measurement notch.

10. The optical height measuring tool as claimed in claim 9 comprising:
the measurement indicator engaging with the measuring portion of the sliding ruler;
the measurement indicator sliding along the measuring portion of the sliding ruler in between the first end and second end; and
the measurement notch indicating the position of the measurement indicator relative to the plurality of visual indicators along the measuring portion.

11. An optical height measuring tool comprising:
a bolt adapter;
a lateral arm;
a sliding ruler;
an adjustable height measurement apparatus;
the bolt adapter comprising a chamber end and an attachment end;
the lateral arm comprising a bolt attachment and an arm portion;
the sliding ruler comprising a ruler adapter and a measuring portion;
the adjustable height measurement apparatus comprising a scope interface and a measurement indicator;
the bolt adapter engaging with a firearm barrel;
the lateral arm connects the bolt adapter to the bottom of the sliding ruler;
the sliding ruler mechanically coupling to the lateral arm;
the sliding ruler sliding along the lateral arm;
the adjustable height measurement apparatus mechanically coupling to the sliding ruler;
the adjustable height measurement apparatus engaging with a firearm scope;
the chamber end being positioned along the bolt adapter opposite the attachment end;
the chamber end engaging within a firearm barrel; and
the attachment end further comprising an attachment bore.

12. The optical height measuring tool as claimed in claim 11 comprising:
the attachment bore being a cavity; and
the attachment bore integrating within the attachment end.

13. The optical height measuring tool as claimed in claim 11 comprising:
the bolt adapter further comprising a perimetric feature in an alternative embodiment;
the perimetric feature being a combination of cavities; and
the perimetric feature matching the shape of the firearm barrel chamber.

14. The optical height measuring tool as claimed in claim 11 comprising:
the lateral arm positioning the sliding ruler in an unobstructed position away from the firearm barrel;
the bolt attachment engaging with the bolt adapter at the attachment bore;
the arm portion protruding from the bolt attachment;
the arm portion further comprising a proximal end and a distal end;
the proximal end being positioned along the arm portion opposite the distal end;
the proximal end securing to the bolt attachment; and
the sliding ruler engaging along the arm portion in between the proximal end and the distal end.

15. The optical height measuring tool as claimed in claim 11 comprising:
the ruler adapter further comprises an arm aperture;
the arm aperture engaging with the arm portion of the lateral arm;
the ruler adapter traversing along the arm portion, towards and away from the lateral arm;
the measuring portion further comprising a plurality of visual indicators, a first end and a second end;
the plurality of visual indicators integrating along the measuring portion;
the plurality of visual indicators being a series of markings; and
the measuring portion positioning perpendicularly to the arm portion.

16. The optical height measuring tool as claimed in claim 11 comprising:
the scope interface engaging with a firearm scope;
the scope interface accommodating various firearm scope sizes;
the measurement indicator further comprising a slot and a measurement notch;
the measurement indicator engaging with the measuring portion of the sliding ruler;
the measurement indicator sliding along the measuring portion of the sliding ruler in between the first end and second end; and
the measurement notch indicating the position of the measurement indicator relative to the plurality of visual indicators along the measuring portion.

17. An optical height measuring tool comprising:
a bolt adapter;
a lateral arm;
a sliding ruler;
an adjustable height measurement apparatus;
the bolt adapter comprising a chamber end and an attachment end;
the lateral arm comprising a bolt attachment and an arm portion;
the sliding ruler comprising a ruler adapter and a measuring portion;
the adjustable height measurement apparatus comprising a scope interface and a measurement indicator;
the bolt adapter engaging with a firearm barrel;
the lateral arm connects the bolt adapter to the bottom of the sliding ruler;
the sliding ruler mechanically coupling to the lateral arm;
the sliding ruler sliding along the lateral arm;
the adjustable height measurement apparatus mechanically coupling to the sliding ruler;
the adjustable height measurement apparatus engaging with a firearm scope;
the chamber end being positioned along the bolt adapter opposite the attachment end;
the chamber end engaging within a firearm barrel;
the attachment end further comprising an attachment bore;
the attachment bore being a cavity;
the attachment bore integrating within the attachment end;
the bolt adapter further comprising a perimetric feature in an alternative embodiment;
the perimetric feature being a combination of cavities; and
the perimetric feature matching the shape of the firearm barrel chamber.

18. The optical height measuring tool as claimed in claim 17 comprising:
the lateral arm positioning the sliding ruler in an unobstructed position away from the firearm barrel;
the bolt attachment engaging with the bolt adapter at the attachment bore;
the arm portion protruding from the bolt attachment;
the arm portion further comprising a proximal end and a distal end;
the proximal end being positioned along the arm portion opposite the distal end;
the proximal end securing to the bolt attachment; and
the sliding ruler engaging along the arm portion in between the proximal end and the distal end.

19. The optical height measuring tool as claimed in claim 17 comprising:
the ruler adapter further comprises an arm aperture;
the arm aperture engaging with the arm portion of the lateral arm;
the ruler adapter traversing along the arm portion, towards and away from the lateral arm;
the measuring portion further comprising a plurality of visual indicators, a first end and a second end;
the plurality of visual indicators integrating along the measuring portion;
the plurality of visual indicators being a series of markings; and
the measuring portion positioning perpendicularly to the arm portion.

20. The optical height measuring tool as claimed in claim 17 comprising:
the scope interface engaging with a firearm scope;
the scope interface accommodating various firearm scope sizes;
the measurement indicator further comprising a slot and a measurement notch;
the measurement indicator engaging with the measuring portion of the sliding ruler;
the measurement indicator sliding along the measuring portion of the sliding ruler in between the first end and second end; and
the measurement notch indicating the position of the measurement indicator relative to the plurality of visual indicators along the measuring portion.
